(19) United States
(12) Patent Application Publication
(10) Pub. No.: US 2023/0117406 A1
(43) Pub. Date: Apr. 20, 2023

(54) Sheet-Like Pseudoboehmite

(71) Applicants: SK Innovation Co., Ltd., Seoul (KR); SK ie technology Co., Ltd., Seoul (KR)

(72) Inventors: Young Eun Cheon, Daejeon (KR); Hye Jin Park, Daejeon (KR); Chang Q Lee, Daejeon (KR); Jae Suk Choi, Daejeon (KR)

(21) Appl. No.: 17/951,218

(22) Filed: Sep. 23, 2022

(30) Foreign Application Priority Data
Sep. 24, 2021 (KR) 10-2021-0126182

(51) Int. Cl. C01F 7/20; H01M 50/431; H01M 50/124; H01M 50/133

(52) U.S. Cl. CPC C01F 7/20; H01M 50/133; H01M 50/431; H01M 50/1245

(57) ABSTRACT

Provided are a nano-sized thin sheet-like pseudoboehmite and a method of producing the same. The method of producing a sheet-like pseudoboehmite is performed by a one-pot method, unlike the conventional method of performing the reaction first in a basic solution, and then performing redispersion in an acidic solution, thereby simplifying the production process, and thus, may be useful in the production industry of a separator for a secondary battery, and the like.

### CROSS-REFERENCE TO RELATED APPLICATION

This application claims priority to Korean Patent Application No. 10-2021-0126182, filed Sep. 24, 2021, the disclosure of which is hereby incorporated by reference in its entirety.

### BACKGROUND OF THE INVENTION

### Field of the Invention

The following disclosure relates to a nano-sized thin sheet-like pseudoboehmite and a method of producing the same.

### Description of Related Art

A separator for a secondary battery is a fine film which increases stability by blocking a contact between a positive electrode and a negative electrode in a secondary battery used in electric vehicles, mobile phones, laptops, and the like to prevent an electrical contact between electrodes. A separator for a lithium secondary battery has pores having a size of several tens of nanometers, through which lithium ions pass to show the function of a battery.

A commonly used polyolefin-based separator is severely shrunk at a high temperature and has physically weak durability. Therefore, when an internal temperature rises due to the occurrence of battery abnormality, the separator is easily deformed, and in serious cases, a contact between electrodes may not be sufficiently prevented to cause explosion by short.

Recently, in the conditions requiring the high output/high capacity of a battery, such as in electric vehicles, power tools, and energy storage systems (ESS), the possibility of ignition and explosion occurring when the behavior of the battery is abnormal is several to tens of times that of an existing battery. Therefore, development of a separator having excellent thermal stability at a high temperature which may prepare for a temperature rise of a battery is desperately needed.

In order to solve the stability problem as such, a composite separator having an inorganic particle layer using inorganic particles formed on one or both surfaces of a conventional polyolefin-based separator was developed. As an example of the inorganic particles used therefor includes alumina, aluminum hydroxide, silica, barium oxide, titanium, oxide, magnesium oxide, magnesium hydroxide, clay, glass powder, boehmite, a mixture thereof, or the like. Stability was improved using the inorganic particles, but is still insufficient, and a study of the stability problem is still needed.

As one of the methods for producing a battery having higher stability, a nano-sized binder is used to further improve the adhesive strength in coating the inorganic particle layer on one or both surfaces of the polyolefin-based separator. Therefore, a study of a nano-sized binder which may produce a more stable battery by improving the adhesive strength between the polyolefin-based separator and the inorganic particle layer is needed.

Meanwhile, pseudoboehmite is a kind of boehmite having a chemical formula of AlO (OH), and is boehmite having a high moisture content and a microcrystal. Nano-sized pseudoboehmite may form a crystal having various forms from an alumina precursor under acidic or basic aqueous solution conditions.

As is currently known, boehmite having forms such as a nanowire or a nanorod is known to be produced under acidic conditions, and boehmite having forms such as a sheet or a plate is known to be formed under basic conditions. As an example, Registration Patent KR 10-0793052 discloses an example in which a plate-like boehmite was synthesized in a basic aqueous solution or in a mixed solution of an acid and a base, and a needle-like boehmite was synthesized in an acidic solution.

However, when boehmite is produced under basic conditions in order to be produced in a sheet form, there still remains a problem that the thickness is not sufficiently thin.

For this, a method of first forming a crystal under basic conditions and growing the crystal in an acidic solution by a post-treatment such as centrifugation or solvent evaporation should be adopted, but the process is complicated and it is still difficult to produce a thin film within 10 nm or less or a thin film within 5 nm or less with the produced thickness.

### SUMMARY OF THE INVENTION

An embodiment of the present invention is directed to providing a sheet-like pseudoboehmite having a significantly small thickness even under acidic conditions, and a method of producing the same.

Another embodiment of the present invention is directed to providing a sheet-like pseudoboehmite having a very small thickness of, as an example, 1 nm to 10 nm, and as another example, 1 nm to 5 nm under acidic conditions, and a method of producing the same.

Another embodiment of the present invention is directed to providing a sheet-like pseudoboehmite having a very small thickness of, as an example, 1 nm to 10 nm, and as another example, 1 nm to 5 nm, having a long diameter and a short diameter of 5 nm to 200 nm, and having a ratio of long diameter to thickness and a ratio of short diameter to thickness of 5 or more, for example, in a range of 5 to 200, under acidic conditions, and a method of producing the same.

Still another embodiment of the present invention is directed to providing a method of producing a sheet-like pseudoboehmite by a one-pot method appropriate for commercialization and a sheet-like pseudoboehmite as the product thereof.

In one general aspect, a method of producing a sheet-like pseudoboehmite having a smaller thickness even under acidic conditions which are known to produce a needle or rod shape is provided.

In an exemplary embodiment of the present disclosure, a method of producing sheet-like pseudoboehmite includes the steps of: step (a) removing a by-product of condensation reaction from an aluminum precursor aqueous solution by distillation; step (b) adding an organic acid to an aluminum precursor aqueous solution from which the by-product has been removed to prepare an acidic solution; and step (c) heating the acidic solution in an autoclavable reactor to perform a reaction.

In an exemplary embodiment of the present disclosure, the acidic solution may have a pH of 2 to 6.

In an exemplary embodiment of the present disclosure, the organic acid may be one or a mixture of two or more selected from the group consisting of an acetic acid, a propionic acid, a butyric acid, a lactic acid, an oxalic acid, a malic acid, a tartaric acid, and a citric acid.

In an exemplary embodiment of the present disclosure, a thinner sheet-like pseudoboehmite may be provided, when one or two or more organic acids selected from an acetic acid and a lactic acid are used as the organic acid.

In an exemplary embodiment of the present disclosure, a mole ratio between the aluminum precursor and the organic acid may be 1:0.001 to 1:1.

In an exemplary embodiment of the present disclosure, step (c) may be heating to 160° C. to 250° C. to perform the reaction for 6 hours to 50 hours or 8 hours to 50 hours.

In an exemplary embodiment of the present disclosure, step (c) may be heating to 160° C. to 250° C. under a pressure of 2 bar to 100 bar to perform the reaction for 6 hours to 25 hours.

In the present disclosure, as the pressure is higher, a time for producing the sheet-like pseudoboehmite may be shortened.

That is, in the present disclosure, a temperature, a pressure, and a time are adjusted in an acidic aqueous solution, thereby producing pseudoboehmite which is conventionally produced in a needle or rod shape into a sheet-like pseudoboehmite.

In an exemplary embodiment of the present disclosure, the sheet-like pseudoboehmite may have a long diameter and a short diameter of 5 nm to 200 nm, and a thickness of 1 nm to 10 nm.

In an exemplary embodiment of the present disclosure, the sheet-like pseudoboehmite may have a ratio of long diameter to thickness and a ratio of short diameter to thickness of 5 to 200.

In another general aspect, a sheet-like pseudoboehmite having a long diameter and a short diameter of 5 nm to 200 nm, and a thickness of, as an example, 1 nm to 10 nm, may be provided.

In an exemplary embodiment of the present disclosure, a pseudoboehmite having the ratio of long diameter to thickness and the ratio of short diameter to thickness in a range of 5 to 200, may be provided.

In an exemplary embodiment of the present disclosure, the sheet-like pseudoboehmite may have a peak full-width at half maximum on the (020) plane in a range of 2θ = 10° to 20° in an X-ray diffraction (XRD) spectrum of 0.85° or more.

In an exemplary embodiment of the present disclosure, the sheet-like pseudoboehmite may have a ratio (I_{B/}I_{A}) of a maximum value of a peak intensity corresponding to 5 ppm to 25 ppm (I_{B}) to a maximum value of a peak intensity corresponding to 60 ppm to 75 ppm (I_{A}) in a solid aluminum nuclear magnetic resonance spectrum of 20 or more.

In another general aspect, a sheet-like pseudoboehmite solution includes: 0.1 wt% to 30 wt% of a sheet-like pseudoboehmite, 0.1 wt% to 10 wt% of an organic acid, and a residual solvent, wherein the pseudoboehmite has a long diameter and a short diameter of 5 nm to 200 nm, and a thickness of 1 nm to 10 nm.

In an exemplary embodiment of the present disclosure, the pseudoboehmite may have a ratio of long diameter to thickness and a ratio of short diameter to thickness of 5 to 200.

In an exemplary embodiment of the present disclosure, the solution may have a pH of 2 to 6.

In another general aspect, a composite separator includes a coating layer formed by coating one or both surfaces of a porous separator with a composition including the sheet-like pseudoboehmite.

In still another general aspect, a secondary battery includes the composite separator.

Other features and aspects will be apparent from the following detailed description, the drawings, and the claims.

### BRIEF DESCRIPTION OF THE DRAWINGS

FIG. 1 is a transmission electron microphotograph (TEM) of the pseudoboehmite produced in Example 1.

FIG. 2 is a transmission electron microphotograph (TEM) of the pseudoboehmite produced in Example 5.

FIG. 3 is a transmission electron microphotograph (TEM) of the pseudoboehmite produced in Comparative Example 1.

FIG. 4 is a transmission electron microphotograph (TEM) of the pseudoboehmite produced in Comparative Example 2.

FIG. 5 is a transmission electron microphotograph (TEM) of the pseudoboehmite produced in Comparative Example 3.

FIG. 6 is a transmission electron microphotograph (TEM) of the pseudoboehmite produced in Comparative Example 4.

FIG. 7 is a transmission electron microphotograph (TEM) of the pseudoboehmite produced in Comparative Example 5.

FIG. 8 is an X-ray diffraction spectrum of the pseudoboehmite produced in Example 1.

FIG. 9 is a solid aluminum nuclear magnetic resonance spectrum of the pseudoboehmite produced in Example 1.

### DESCRIPTION OF THE INVENTION

The terms used in the present disclosure have the same meanings as those commonly understood by a person skilled in the art. In addition, the terms used herein are only for effectively describing a certain specific example, and are not intended to limit the present disclosure.

The singular form used in the specification of the present disclosure and the claims appended thereto may be intended to also include a plural form, unless otherwise indicated in the context.

Throughout the present specification describing the present disclosure, unless explicitly described to the contrary, “comprising” any elements will be understood to imply further inclusion of other elements rather than the exclusion of any other elements.

In the present disclosure, the “long diameter” refers to the longest length of a pseudoboehmite crystal. The “short diameter” refers to the longest length of orthogonal direction by long diameter axis.

In the present disclosure, the long diameter, the short diameter, and the thickness are determined from averages of values measured by arbitrarily selecting 20 particles, respectively, in five transmission electron microscope (TEM, JEOL Ltd., JEM-2100F) images.

In the present disclosure, “sheet-like” pseudoboehmite refers to pseudoboehmite particles in a sheet form, which means that the thickness of the pseudoboehmite is smaller than the long diameter or the short diameter of a plane portion. Since the pseudoboehmite according to an exemplary embodiment of the present disclosure is significantly thin, a ratio of long diameter to thickness or a ratio of short diameter to thickness may be 5 to 200.

In the present disclosure, a “rod form” is pseudoboehmite having a form of a long diameter larger than a short diameter, and a ratio of long diameter to short diameter may be 5 or more or 10 or more. A “needle form” has a pointed cross section and may have a long diameter to short diameter ratio larger than that of a rod form.

The inventors of the present disclosure conducted a lot of studies for solving the problems, and as a result, succeeded in producing a pseudoboehmite having a significantly small thickness while having a sheet form not a needle or rod form under acidic conditions.

In addition, the inventors of the present disclosure found that a sheet-like pseudoboehmite may be produced by a one pot method without a redispersion step under acidic conditions as a post-treatment after a crystallization step under basic conditions, thereby completing the present disclosure.

Hereinafter, the present disclosure will be described in detail.

The inventors of the present disclosure found that by adjusting a temperature, a pressure, and a time in an acidic aqueous solution, a sheet-like pseudoboehmite may be produced even by a conventional method of producing only a needle or rod shape under an acidic solution for the first time, thereby completing the present disclosure.

An exemplary embodiment of the present disclosure for achieving the object is to provide a method of producing sheet-like pseudoboehmite including the steps of: step (a) removing a by-product of condensation reaction from an aluminum precursor aqueous solution by distillation; step (b) adding an organic acid to an aluminum precursor aqueous solution from which the by-product has been removed to prepare an acidic solution; and step (c) heating the acidic solution in an autoclavable reactor to perform a reaction.

Hereinafter, each step of the production method will be described.

First, step (a) of removing a by-product of condensation reaction (for example, referring to isopropyl alcohol when an aluminum precursor is aluminum isopropoxide) from an aluminum precursor aqueous solution by distillation will be described in detail.

The aluminum precursor refers to an aluminum-containing material, and for example, may be aluminum acetates, aluminum nitrates, aluminum sulfates, aluminum halides, aluminum sulfides, aluminum hydroxides, aluminum oxides, aluminum oxyhydroxides, aluminum alkoxides, or mixtures thereof. A more specific example of the aluminum precursor may include Al₂O₃, Al (OH)₃, Al₂ (SO₄)₃, AlCl₃, Al (O-i-Pr)₃, Al (NO₃)₃, AlF₃, or a mixture thereof, but is not limited thereto. In particular, an aluminum alkoxide is more easily hydrolyzed, and is characterized in that it is easy to remove by-products. Specifically, an aluminum alkoxide having an alkoxy group having 2 to 5 carbon atoms may be used as the aluminum precursor, and for example, may be aluminum ethoxide, aluminum isopropoxide, aluminum n-butoxide, aluminum sec-butoxide, and the like.

In an embodiment, the experiment conditions of the distillation may be appropriately changed as long as the by-product of condensation reaction described above may be removed, and for example, it may be performed by heating the aluminum precursor aqueous solution at a temperature of 85° C. to 120° C. or 80° C. to 100° C. Specifically, the distillation may be distillation under reduced pressure, and more specifically, the distillation may be performed under a reduced pressure of 800 mbar or less, 700 mbar or less, 600 mbar or less, or 300 mbar or less. For example, the distillation may be performed under a reduced pressure of 300 mbar to 800 mbar, 300 mbar to 700 mbar, or 300 mbar to 600 mbar.

The step of removing the by-product in an exemplary embodiment of the present disclosure may be, for example, heating an aluminum isopropoxide aqueous solution at 95° C. to remove isopropyl alcohol which is the by-product of the condensation reaction in the solution while reducing the pressure to 500 mbar.

In the step of removing the by-product by heating and distilling the by-product, when an organic acid is added, though the cause is not known, not a sheet-like pseudoboehmite but a needle or rod-like pseudoboehmite is produced, and thus, it is one characteristic of the present disclosure not to add an organic acid in the step of removing the by-product.

The organic acid is added to the reaction solution from which the by-product has been removed, and the solution is added to an autoclavable reactor to perform the reaction at 160° C. or a reaction time of higher for 6 hours or more, thereby producing sheet-like pseudoboehmite.

The temperature, the pressure, and the reaction conditions may be changed as long as the sheet-like pseudoboehmite to be desired in the present disclosure is produced.

Hereinafter, step (b) of adding an organic acid to the aluminum precursor aqueous solution from which the by-product has been removed to produce an acidic solution will be described in more detail.

The pH of the acidic solution is not particularly limited, but may be 2 to 6, 3 to 5, or 3.3 to 4.6.

A solution having the pH in the above range using the organic acid for producing the sheet-like pseudoboehmite of the present disclosure is used, and the synthesis is performed under the pressure (including normal pressure) and the heating conditions of the present disclosure, thereby producing a sheet-like pseudoboehmite, not a needle or rod form. Besides, the produced pseudoboehmite may have a very small thickness of 1 nm to 10 nm, or 1 nm to 5 nm.

In addition, the produced pseudoboehmite may have a ratio of long diameter to thickness and a ratio of short diameter to thickness of 5 to 200, and a ratio of long diameter to short diameter of 5 or more. For example, the diameter of long diameter to short diameter may be 10 or more.

In order to achieve the object of the present disclosure, the mole ratio of the aluminum precursor and the organic acid may be, for example, 1:0.001 to 1:1, specifically 1:0.01 to 1:1, and more specifically 1:0.05 to 1:0.5, but is not necessarily limited thereto.

The organic acid serves to adjust pH for producing the sheet-like pseudoboehmite, and is not limited as long as the object of the present disclosure is achieved, but may be any one or a mixture of two or more of an acetic acid, a propionic acid, a butyric acid, a lactic acid, an oxalic acid, a malic acid, a tartaric acid, and a citric acid.

When any one or more organic acids selected from an acetic acid or a lactic acid is used as the organic acid, a thinner sheet form may be obtained.

Hereinafter, step (c) of heating the acidic solution in an autoclavable reactor to perform the reaction will be described in more detail.

The step (c) is a step of heating the acidic solution in an autoclavable reactor to perform the reaction, and the acidic solution may be heated at a temperature of 160° C. or higher under normal pressure or certain pressure in an autoclavable reactor, and reacted for 6 hours or more.

In an exemplary embodiment of the present disclosure, the heating reaction temperature may be 160° C. or higher, for example, 160° C. to 250° C., 165° C. to 250° C., or 170° C. to 250° C.

The reaction time of reacting by heating may be 6 hours or more, 8 hours or more, 10 hours or more, 12 hours or more, specifically 15 hours or more and 50 hours or less, and is not limited thereto, but for example, may be 6 hours to 50 hours or 8 hours to 50 hours.

In an exemplary embodiment of the present disclosure, when the reaction time is 5 hours or less, though the cause is not known, needle and rod-like pseudoboehmites are produced, and the sheet-like pseudoboehmite of the present disclosure may not be obtained.

The reason is unclear, but it is considered that when the acidic solution is crystallized at a temperature of lower than 160° C., the crystallization does not proceed well, and thus, the crystal itself is not formed or a mixture of needle and rod forms may be formed, and particles in a needle or rod form may be produced. When the crystallization is performed at a temperature higher than 250° C. or higher, a crystal size is increased due to excessive crystal growth, the sheet form may disappear, and since the crystal size is increased, when it is coated on the surface of a separator, coating performance may be deteriorated and a coating layer in an ultrathin film form may not be formed, which is thus not preferred.

That is, when the acidic solution is reacted for less than 6 hours in the reaction in the reaction in the above temperature range, the time is not sufficient for producing the sheet-like pseudoboehmite, and thus, needle or rod-like particles, not a sheet form, may be produced. Therefore, it is preferred to perform the reaction by heating to the temperature range for 6 hours or more, specifically 8 hours or more for producing the sheet-like pseudoboehmite to be desired in the present disclosure.

In addition, in an exemplary embodiment of the present disclosure, a reaction pressure in the reaction in the autoclavable reactor may be a normal pressure when the reaction time is sufficiently long in the above temperature range since a sheet-like pseudoboehmite is produced, but a pressure increase is possible for obtaining a sheet form for a shortened reaction time. However, in order to produce a sheet-like pseudoboehmite having a stably excellent form even in a pressurized state and at the reaction temperature, the sheet-like pseudoboehmite may be produced only by performing the reaction by heating to 160° C. to 250° C. for 6 hours or more under a pressure of 2 bar to 100 bar in an autoclavable reactor, and when the conditions are not met, a needle or rod-like pseudoboehmite, not a sheet form, may be produced, which is thus, not preferred.

The following conditions may be appropriately changed depending on the experimental environment within the extent where the object of the present disclosure is achieved, of course, but for example, the reaction pressure may be 2 bar to 50 bar, or 3 bar to 25 bar, and the reaction time when the reaction is performed at a normal pressure may be 6 hours or more, 8 hours or more, or 10 hours or more, and for example, 6 hours to 25 hours.

In addition, as a pressurization method, as an example, the temperature may be raised in a closed pressurized container to increase the pressure to the vapor pressure of the solvent, or air or inert gas may be added to adjust the pressure.

Hereinafter, the sheet-like pseudoboehmite produced by the production method will be described in detail.

The sheet-like pseudoboehmite may have, for example, a long diameter and a short diameter of 5 nm to 200 nm, 5 nm to 100 nm, or 5 nm to 50 nm, and a ratio of long diameter to thickness and a ratio of short diameter to thickness of 5 to 200, 5 to 100, or 5 to 50, but is not limited thereto. The above-described long diameter and the short diameter may be the same as or different from each other, and the ratio of long diameter to thickness and the ratio of short diameter to thickness may be the same as or different from each other.

In addition, the sheet-like pseudoboehmite may have a thickness of 10 nm or less, 5 nm or less, 4 nm or less, 2 nm or less and 0.1 nm or more or 1 nm or more. For example, the thickness may be 1 nm to 10 nm, 1 nm to 5 nm, 1 nm to 4 nm, or 1 nm to 2 nm.

Another exemplary embodiment of the present disclosure, a sheet-like pseudoboehmite having a long diameter and a short diameter of 5 nm to 200 nm, 5 nm to 100 nm, or 5 nm to 50 nm, and a thickness of 1 nm to 10 nm or 1 nm to 5 nm may be provided.

A ratio of long diameter to thickness and a ratio of short diameter to thickness of the pseudoboehmite may be 5 to 200, 5 to 100, or 5 to 50.

In addition, the pseudoboehmite may have a peak full-width at half maximum (FWHM) on the (020) plane in a range of 2θ = 10° to 20° in an X-ray diffraction (XRD) spectrum of 0.85° or more, 2.0° or more, 3.0° or more, 4.0° or more, 8.35° or less, 7.0° or less, or 5.0° or less.

The peak full-width at half maximum may be, for example, 0.85° to 8.35°, 0.85° to 7.0°, 2.0° to 7.0°, 3.0° to 7.0°, 4.0° to 7.0°, or 4.0° to 5.0°, and the following Equation 1 is the Scherrer equation and the crystal size may be calculated therefrom.

$$\text{L} \text{=} \text{0} \text{.9} \text{*} \text{λ} \text{/} \left(\text{β} \text{*} \text{cosθ}\right)$$

wherein L = crystal size,
λ = Cu Ka wavelength,
β = full width at half maximum, and
θ = Bragg Angle; central diffraction angle of full width at half maximum.

When the peak full-width at half maximum on the (020) plane in a range of 2θ = 10° to 20° is 0.85° or more, the crystal size may be calculated as 10 nm or less, and when it is 8.35° or less, the crystal size may be calculated as 1 nm or more.

The pseudoboehmite shows the peak full-width at half maximum on the (020) plane in a range of 2θ = 10° to 20° in the X-ray diffraction (XRD) spectrum of 0.85° or more, from which it is confirmed that it is a pseudoboehmite having a thickness of 10 nm or less.

In addition, the sheet-like pseudoboehmite may have a ratio of a maximum value of a peak intensity corresponding to 5 ppm to 25 ppm to a maximum value of a peak intensity corresponding to 60 ppm to 75 ppm in the solid aluminum nuclear magnetic resonance spectrum of 20 or more.

A peak corresponding to a chemical shift value of 5 ppm to 25 ppm results from an aluminum octahedron (Oh) having a pseudoboehmite structure, and a peak corresponding to a chemical shift value of 60 ppm to 75 ppm results from an aluminum tetrahedron (Td) which is an impurity. The pseudoboehmite according to the present disclosure has a ratio of the maximum value of the peak intensity corresponding to 5 ppm to 25 ppm to the maximum value of the peak intensity corresponding to 60 ppm to 75 ppm of 20 or more or 30 or more, and thus, is found to be a pseudoboehmite having less impurity and high purity. A higher ratio shows higher-purity particles, and thus, the upper limit is not limited.

Another exemplary embodiment of the present disclosure may provide a sheet-like pseudoboehmite solution including: 0.1 wt% to 30 wt% of a sheet-like pseudoboehmite, 0.1 wt% to 10 wt% of an organic acid, and a residual solvent, wherein the pseudoboehmite may have a long diameter and a short diameter of 5 nm to 200 nm, 5 nm to 100 nm, or 5 nm to 50 nm, and a thickness of 1 nm to 10 nm or 1 nm to 5 nm.

The pseudoboehmite of the pseudoboehmite solution may have a ratio of long diameter to thickness and a ratio of short diameter to thickness of the pseudoboehmite of 5 to 200, 5 to 100, or 5 to 50.

The pseudoboehmite solution may be a pseudoboehmite aqueous solution.

The solvent is not limited as long as it dissolves the aluminum precursor described above, but may be water, or an organic solvent instead of water, and for example, may be any one or more selected from alcohol, ether, ketone, aldehyde, a mixture thereof, and the like.

Specifically, the sheet-like pseudoboehmite may be included in a range of 0.1 wt% to 30 wt%, 0.5 wt% to 20 wt%, or 1 wt% to 10 wt% with respect to the weight of the total solution, the organic acid may be included in a range of 0.1 wt% to 10 wt%, 0.2 wt% to 8 wt%, or 0.4 wt% to 5 wt% with respect to the weight of the total solution, and the residual may be the solvent as described above.

The solution may have a pH of 2 to 6 or 3 to 5.

Another exemplary embodiment of the present disclosure may provide a composite separator including a coating layer formed by coating one or both surfaces of a porous separator with a composition including the sheet-like pseudoboehmite. The coating layer may refer to a particle layer in which particles are laminated adjacent to each other to form space between particles.

The sheet-like pseudoboehmite is included in the coating layer, thereby producing a composite separator having excellent adhesive strength between the porous separator and the coating layer, and thus, the composite separator may be used in producing a secondary battery having improved thermal stability.

The above description may be applied to the sheet-like pseudoboehmite, and the porous separator is not limited as long as it is commonly used as the separator of a secondary battery.

As an example, it may be a woven fabric, a non-woven fabric, a porous film, and the like. The material of the porous separator is not limited, but as an example, may be formed of any one or a mixture of two or more selected from the group consisting of polyethylene, polypropylene, polybutylene, polypentene, polymethylpentene, polyethylene terephthalate, polybutylene terephthalate, polyacetal, polyamide, polycarbonate, polyimide, polyethersulfone, polyphenylene oxide, polyphenylene sulfide, polyethylene naphthalene, a copolymer thereof, and the like.

The thickness of the porous separator is not limited, and may be 1 µm to 100 µm, specifically 5 to 50 µm, and more specifically 6 µm to 30 µm, which are the ranges commonly used in the art.

The coating method is not limited, and specifically for example, it may be a common coating method such as dip coating, flow coating, knife coating, roll coating, gravure coating, and spray coating.

Another exemplary embodiment of the present disclosure may provide a secondary battery including the composite separator. The secondary battery may be, for example, a lithium secondary battery, a sodium secondary battery, or a magnesium secondary battery. The form of the lithium secondary battery is not particularly limited, and may be a lithium ion battery, a lithium ion polymer battery, a lithium sulfur battery, and the like.

The secondary battery including the composite separator has the coating layer using the sheet-like pseudoboehmite described above, thereby having improved adhesive strength between the porous separator and the coating layer to have excellent thermal stability.

Hereinafter, the examples and the comparative examples of the present disclosure will be described in detail. However, the examples and the comparative examples described later are only illustrative of a part of the present disclosure, and the present disclosure is not limited thereto.

The long diameter, the short diameter, and the thickness measured later were determined from averages of values measured by arbitrarily selecting 20 particles, respectively, in five transmission electron microscope (TEM, JEOL Ltd., JEM-2100F) images.

### Example 1

306 g of aluminum isopropoxide was dissolved in 1600 g of water to prepare an aluminum precursor solution. The aluminum precursor solution was heated to 95° C. while decreasing the pressure to 500 mbar to remove isopropyl alcohol which was the by-product of the condensation reaction in the solution. 10 g of a lactic acid was added to the aluminum precursor solution from which isopropyl alcohol had been removed, and the pH was adjusted to 4.5. The aluminum precursor solution having a pH of 4.5 was heated at 5° C./min in a pressurized reactor to set the reaction temperature to 170° C. and then the reaction was performed with stirring for 24 hours. The solution after the reaction was naturally cooled.

The pseudoboehmite prepared above was analyzed for the shape and the purity using TEM, an X-ray diffraction method, and a nuclear magnetic resonance method.

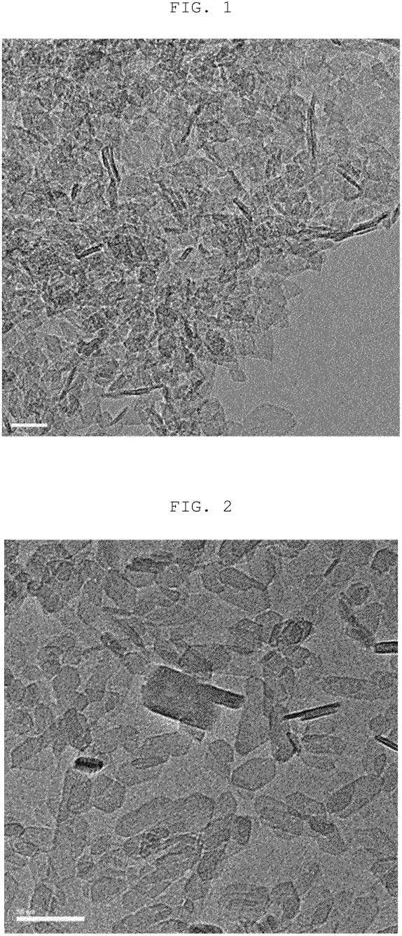

First, the results of analysis with a transmission electron microscope (TEM) are shown in FIG. 1. The lengths of the resulting long diameter and short diameter were determined from the averages of the values measured by arbitrarily selecting 20 particles, respectively, from five transmission electron microscope images. It was confirmed that the pseudoboehmite had the long diameter and the short diameter of 20 nm and 10 nm, respectively, had a rectangular sheet form, and had the thickness of the sheet form of 2 nm or less.

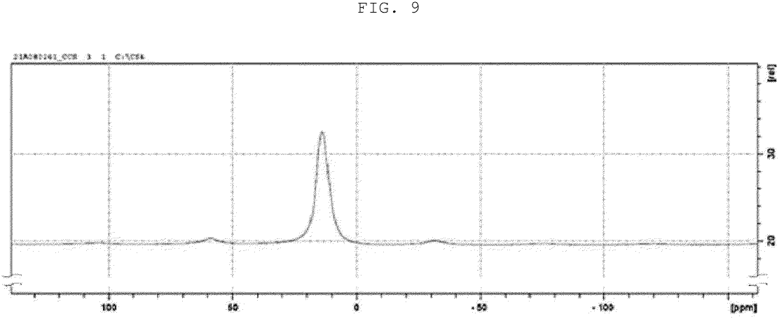

Next, the pseudoboehmite produced above was analyzed with the X-ray diffraction method, and is shown in FIG. 8. The measurement was performed using A Cu Kα wavelength, under the analysis conditions of 40 kV and 30 mA, with continuous scan to 10° to 80° with a step size of 0.02626°. The peak full-widths at half maximum (FWHM) on the (020), (200), and (002) planes in a range of 2θ = 10° to 80° of the X-ray diffraction spectrum were substituted into the Scherrer equation to calculate the crystal size, and the results are shown in Table 1. As seen from the results of Table 1, it was confirmed that the pseudoboehmite produced in Example 1 was a sheet-like structure.

The Scherrer equation and each item are as follows:
L = 0.9 * λ / (β * cosθ)
wherein L = crystal size,
λ = Cu K∝ wavelength,
β = full width at half maximum, and
θ = Bragg Angle; central diffraction angle of full width at half maximum.

TABLE 1

| | |
|---|---|
| | Example 1 |
| (020) plane | 2 nm |
| (200) plane | 14 nm |
| (002) plane | 8 nm |

Finally, the solid aluminum nuclear magnetic resonance analysis of the pseudoboehmite produced was performed, and the analysis spectrum is shown in FIG. 9. For the measurement sample, a 4 mm rotor was used at 600 MHz, and 0.5 µs of pulse and 5 seconds of delay time were set under spinning conditions of 12 KHz. A peak corresponding to a chemical shift value of 5 ppm to 25 ppm results from an aluminum octahedron (Oh) having a pseudoboehmite structure and a peak corresponding to a chemical shift value of 60 ppm to 75 ppm results from an aluminum tetrahedron (Td) which is an impurity, and since only the peak corresponding to an aluminum octahedron was detected from the pseudoboehmite produced in Example 1, it was confirmed to be produced in a high purity.

### Example 2

The pseudoboehmite was produced in the same manner as in Example 1, except that the aluminum precursor solution having a pH of 4.5 was heated at 5° C. per minute in a pressurized reactor filled with 5 bar of N₂ to set the reaction temperature to 180° C., and then the reaction was performed with stirring for 6 hours.

When the long diameter and the short diameter were measured in the same manner as in Example 1, it was confirmed that the pseudoboehmite had the long diameter and the short diameter of 20 nm and 10 nm, respectively, had a rectangular sheet form, and had the thickness of the sheet form of 2 nm or less.

### Example 3

The pseudoboehmite was produced in the same manner as in Example 1, except that the aluminum precursor solution having a pH of 4.5 was heated at 5° C. per minute in a pressurized reactor filled with 10 bar of N₂ to set the reaction temperature to 170° C., and then the reaction was performed with stirring for 6 hours.

When the long diameter and the short diameter were measured in the same manner as in Example 1, it was confirmed that the pseudoboehmite had the long diameter and the short diameter of 20 nm and 10 nm, respectively, had a rectangular sheet form, and had the thickness of the sheet form of 2 nm or less.

### Example 4

The pseudoboehmite was produced in the same manner as in Example 1, except that the reaction temperature was set to 200° C. and then the reaction was performed with stirring for 6 hours.

When the long diameter and the short diameter were measured in the same manner as in Example 1, it was confirmed that the pseudoboehmite had the long diameter and the short diameter of 30 nm and 20 nm, respectively, had a rectangular sheet form, and had the thickness of the sheet form of 2 nm or less.

### Example 5

The pseudoboehmite was produced in the same manner as in Example 3, except that 28 g of an acetic acid was added instead of the lactic acid, and the pH was adjusted to 3.4.

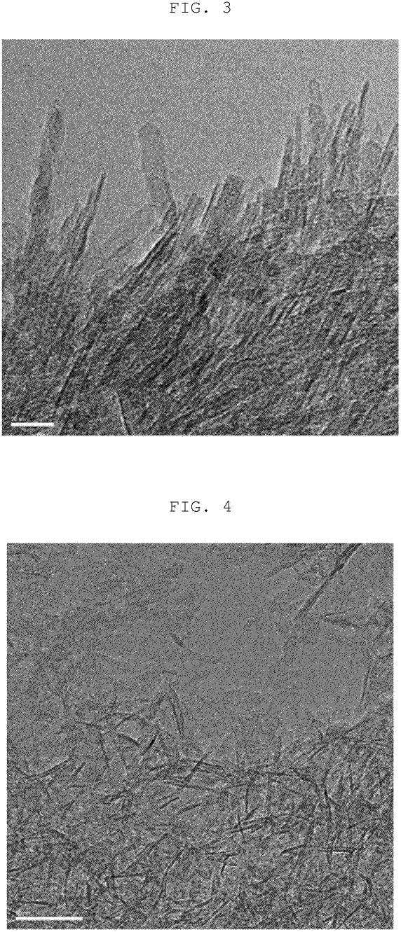

The long diameter and the short diameter were measured in the same manner as in Example 1, and are shown in FIG. 2. It was confirmed that the pseudoboehmite had the long diameter and the short diameter of 60 nm and 20 nm, respectively, had a rectangular sheet form, and had the thickness of the sheet form of 4 nm or less.

### Comparative Example 1

The pseudoboehmite was produced in the same manner as in Example 1, except that the 28 g of an acetic acid was added to the aluminum precursor solution from which isopropyl alcohol had been removed to set the pH to 3.3, the aluminum precursor solution of pH 3.3 was heated at 5° C. per minute to set the reaction temperature to 150° C., and then the reaction was performed with stirring for 6 hours.

It was confirmed that the product produced in Comparative Example 1 had a rod shape having a long diameter and a short diameter of 50 nm to 70 nm and 6 nm to 10 nm, respectively, which is confirmed in FIG. 3.

### Comparative Example 2

The pseudoboehmite was produced in the same manner as in Example 1, except that the aluminum precursor solution of pH 4.5 was heated at 5° C. per minute to set the reaction temperature to 150° C., and then the reaction was performed with stirring for 6 hours.

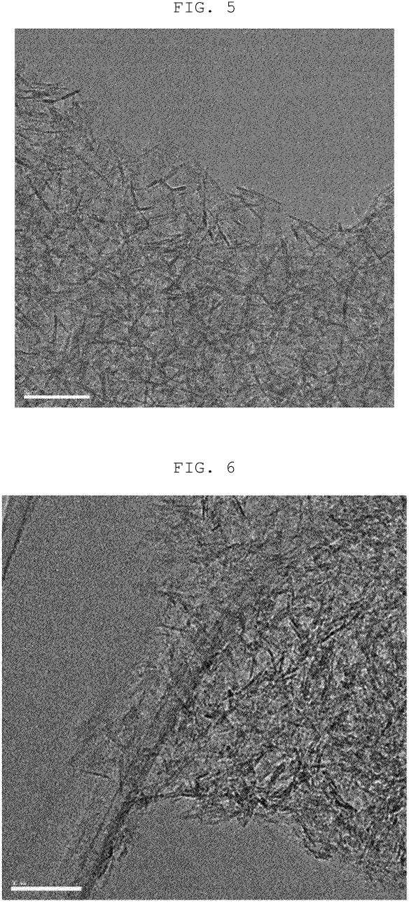

It was confirmed that the product produced in Comparative Example 2 had a bundle shape formed by gathering needles having a long diameter and a short diameter of 30 nm to 50 nm and 5 nm or less, respectively, which is confirmed in FIG. 4.

### Comparative Example 3

The pseudoboehmite was produced in the same manner as in Comparative Example 2, except that 0.9 g of citric acid was added to the aluminum precursor solution from which isopropyl alcohol had been removed to adjust the pH to 4.5.

It was confirmed that the product produced in Comparative Example 3 was needles having a long diameter and a short diameter of 30 nm to 50 nm and 5 nm or less, respectively, which is confirmed in FIG. 5.

### Comparative Example 4

The pseudoboehmite was produced in the same manner as in Comparative Example 2, except that 2.3 g of oxalic acid was added to the aluminum precursor solution from which isopropyl alcohol had been removed to adjust the pH to 2.9.

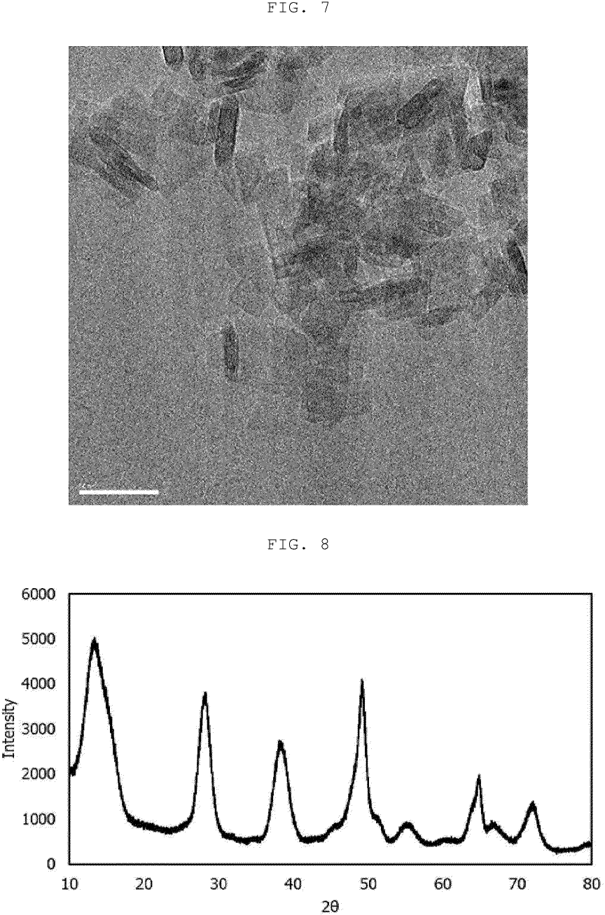

It was confirmed that the product produced in Comparative Example 4 was needles having a long diameter and a short diameter of 30 nm to 50 nm and 5 nm or less, respectively, which is confirmed in FIG. 6.

### Comparative Example 5

35.45 g of aluminum nitrate was dissolved in 141 g of water to prepare an aluminum precursor solution. Sodium hydroxide (NaOH) was added to the aluminum precursor solution to adjust the pH to 12. The aluminum precursor solution of pH 12 was mixed at room temperature for 1 hour. When it became a white cloudy solution from an initial gel state, it was transferred to a reactor. It was heated at 5° C. per minute in the reactor to set the reaction temperature to 170° C., and then reacted with stirring for 48 hours. The solution after the reaction was naturally cooled.

When the long diameter and the short diameter were measured in the same manner as in Example 1, it was confirmed that the pseudoboehmite had the long diameter and the short diameter of 50 nm and 30 nm, respectively, had a sheet form with a thickness, and had the thickness of the sheet form of 10 nm or more, which is shown in FIG. 7.

### Comparative Example 6

28 g of an acetic acid and 1600 g of water were stirred at 75° C. 306 g of aluminum isopropoxide was dissolved in the solution to prepare and aluminum precursor solution. The aluminum precursor solution containing an acetic acid was heated to 95° C. while decreasing the pressure to 500 mbar to remove isopropyl alcohol which was the by-product of the condensation reaction in the solution. The aluminum precursor solution from which alcohol had been removed was heated at 5° C./min in a pressurized reactor to set the reaction temperature to 180° C. and then the reaction was performed with stirring for 7 hours. The solution after the reaction was naturally cooled.

It was confirmed that the product produced in Comparative Example 6 had a rod shape having a long diameter and a short diameter of 50 nm to 70 nm and 6 nm to 10 nm, respectively.

### Comparative Example 7

The pseudoboehmite was produced in the same manner as in Comparative Example 1, except that the aluminum precursor solution of pH 3.3 was heated at 5° C. per minute in a pressurized reactor to set the reaction temperature to 180° C., and then the reaction was performed with stirring for 5 hours.

It was confirmed that the product produced in Comparative Example 7 had a rod shape having a long diameter and a short diameter of 50 nm to 70 nm and 6 nm to 10 nm, respectively.

In Examples 1 to 4, a lactic acid was used as the organic acid to perform crystallization at 170° C. to 200° C. to produce the sheet-like pseudoboehmite, but in Comparative Example 2, a lactic acid was used, but the crystallization was performed at 150° C. to produce the needle-like pseudoboehmite.

In addition, Example 5, a lactic acid was used as the organic acid to perform crystallization at 170° C. to produce the sheet-like pseudoboehmite, but in Comparative Example 1, an acetic acid was used, but the crystallization was performed at 150° C. to produce the rod-like pseudoboehmite.

Furthermore, the pseudoboehmite produced has a thickness of 4 nm or less or 2 nm or less, and according to an exemplary embodiment of the present disclosure, the sheet-like pseudobehmite having a significantly thin thickness may be prepared.

In addition, in Comparative Example 6, when a process of adding the organic acid and hydrolyzing the aluminum precursor solution to remove the by-product is performed, it was found that a rod form was obtained even with the reaction at 180° C. for 7 hours, and thus, the object of the present disclosure may not be obtained by the process of removing the by-product in the state of adding the organic acid.

From the experiment results, it was found that when an aluminum precursor is hydrolyzed in the absence of an organic acid and a by-product is removed, and then the organic acid is added to adjust the pH to sufficiently impart the heating with pressurization and the reaction time, a sheet shape may be obtained even with the use of an acidic aqueous solution which conventionally produces only a needle or rod shape.

The method of producing a sheet-like pseudoboehmite provided in one aspect of the present disclosure may produce a significantly thin sheet-like pseudoboehmite.

The method of producing a sheet-like pseudoboehmite provided in another aspect of the present disclosure may be performed by a one-pot method, unlike the conventional method of performing the reaction first in a basic solution, and then performing redispersion and crystallization in an acidic solution, thereby simplifying the production process.

The composite separator for a secondary battery provided in another aspect of the present disclosure may be used for manufacturing a secondary battery having improved thermal stability by including a coating layer formed using the sheet-like pseudoboehmite.

In the present disclosure, as the pressure is higher, a time for producing the sheet-like pseudoboehmite may be shortened.

That is, in the present disclosure, sheet-like boehmite can be prepared by adjusting the temperature, pressure, and time in the acidic aqueous solution by means that are conventionally known to be prepared only in the shape of needles or rods in an acidic solution.

1. A method of producing a sheet-like pseudoboehmite, the method comprising the steps of:
step (a) removing a by-product of condensation reaction from an aluminum precursor aqueous solution by distillation;
step (b) adding an organic acid to the aluminum precursor aqueous solution from which the by-product has been removed to prepare an acidic solution; and
step (c) heating the acidic solution in an autoclavable reactor to perform a reaction.

2. The method of producing a sheet-like pseudoboehmite of claim 1, wherein the acidic solution has a pH of 2 to 6.

3. The method of producing a sheet-like pseudoboehmite of claim 1, wherein a mole ratio between the aluminum precursor and the organic acid is 1:0.001 to 1:1.

4. The method of producing a sheet-like pseudoboehmite of claim 1, wherein the organic acid is one or a mixture of two or more selected from the group consisting of an acetic acid, a propionic acid, a butyric acid, a lactic acid, an oxalic acid, a malic acid, a tartaric acid, and a citric acid.

5. The method of producing a sheet-like pseudoboehmite of claim 1, wherein step (c) is heating to 160° C. to 250° C. to perform the reaction for 6 hours to 50 hours.

6. The method of producing a sheet-like pseudoboehmite of claim 1, wherein step (c) is heating to 160° C. to 250° C. under a pressure of 2 bar to 100 bar to perform the reaction for 6 hours to 25 hours.

7. The method of producing a sheet-like pseudoboehmite of claim 1, wherein the sheet-like pseudoboehmite has a long diameter and a short diameter of 5 nm to 200 nm, and a thickness of 1 nm to 10 nm.

8. The method of producing a sheet-like pseudoboehmite of claim 1, wherein the sheet-like pseudoboehmite has a ratio of long diameter to thickness and a ratio of short diameter to thickness of 5 to 200.

9. A sheet-like pseudoboehmite having a long diameter and a short diameter of 5 nm to 200 nm, and a thickness of 1 nm to 10 nm.

10. The sheet-like pseudoboehmite of claim 9, wherein a ratio of long diameter to thickness and a ratio of short diameter to thickness are 5 to 200.

11. The sheet-like pseudoboehmite of claim 9, wherein a peak full-width at half maximum on plane in a range of 2θ = 10° to 20° in an X-ray diffraction (XRD) spectrum is 0.85° to 8.35°.

12. The sheet-like pseudoboehmite of claim 9, wherein a ratio (I_{B}/I_{A}) of a maximum value of a peak intensity corresponding to 5 ppm to 25 ppm (I_{B}) to a maximum value of a peak intensity corresponding to 60 ppm to 75 ppm (I_{A}) in a solid aluminum nuclear magnetic resonance spectrum is 20 or more.

13. A sheet-like pseudoboehmite solution comprising: 0.1 wt% to 30 wt% of a sheet-like pseudoboehmite, 0.1 wt% to 10 wt% of an organic acid, and a residual solvent,
wherein the sheet-like pseudoboehmite has a long diameter and a short diameter of 5 nm to 200 nm, and a thickness of 1 nm to 10 nm.

14. The sheet-like pseudoboehmite solution of claim 13, wherein a ratio of long diameter to thickness and a ratio of short diameter to thickness are 5 to 200.

15. The sheet-like pseudoboehmite solution of claim 13, wherein the solution has a pH of 2 to 6.

16. A composite separator comprising a coating layer formed by coating one or both surfaces of a porous separator with a composition including the sheet-like pseudoboehmite of claim 9.

17. A secondary battery comprising the composite separator of claim 16.
